(19) United States
(12) Patent Application Publication
(10) Pub. No.: US 2026/0154758 A1
(43) Pub. Date: Jun. 4, 2026

(54) GUARANTEED AVAILABILITY DECISION SUPPORT SYSTEM FOR NITROGEN MANAGEMENT IN RAINFED CROP PRODUCTION

(71) Applicant: SENTINEL AG, INC., Ithaca, NE (US)

(72) Inventors: Jackson Stansell, Columbia, AL (US); Val Kovalsky, Lincoln, NE (US)

(21) Appl. No.: 19/407,994

(22) Filed: Dec. 3, 2025

Related U.S. Application Data
(60) Provisional application No. 63/727,850, filed on Dec. 4, 2024.

(51) Int. Cl. G06Q 50/02; A01C 21/00

(52) U.S. Cl. CPC G06Q 50/02; A01C 21/007

(57) ABSTRACT

A system is disclosed. The system includes a controller, wherein the controller includes one or more processors configured to execute program instructions stored in memory, the program instructions configured to cause the one or more processors to: receive information of a natural environment and management practices for a specified area of a field; initiate automated collection of data; determine if there is an approaching nitrogen demand; estimate the current approaching nitrogen demand and recommending a rate of nitrogen application based on the estimated current or approaching nitrogen demand; and calculate at least one nitrogen uptake improvement based on the recommended rate of nitrogen application.

### CROSS-REFERENCE TO RELATED APPLICATIONS

The present application claims the benefit under 35 U.S.C. § 119(e) of U.S. Provisional Application Ser. No. 63/727,850, filed Dec. 4, 2024, entitled GUARANTEED AVAILABILITY DSS FOR NITROGEN MANAGEMENT IN RAINFED CROP PRODUCTION, which is incorporated herein by reference in the entirety.

### TECHNICAL FIELD

This disclosure relates broadly to crop management, and, more particularly, to nitrogen sidedressing based on environmental data.

### BACKGROUND

Sidedressing is a significant and growing nitrogen application practice in cereal grain cultivation, especially for corn, due to demands for higher yields, profits, and water resource preservation. It involves applying incremental nitrogen fertilizer to crops during the growing season to ensure optimal nitrogen supply and maximize yield. The timing of nitrogen sidedress is critical due to nitrogen demand dynamics of corn and other cereal grains throughout their growth, including periods of higher and lower nitrogen demand.

The adoption of nitrogen (N) fertilizer sidedress may improve fertilizer utilization, crop yield, crop quality, and environmental stewardship in cereal grain production, and in particular, corn production. Farmers and agronomists often work together to build nitrogen management plans based on factors such as, but not limited to, the crop(s) being grown, equipment available, preferred application techniques and fertilizer products, profitability goals, efficiency goals, local regulations, expected crop outcomes, historical weather, and anticipated weather conditions during crop growth. Farmers and agronomists are ultimately trying to resolve what series of nitrogen application rates and timings is most likely to produce the optimal outcome (e.g., for profit, yield, or efficiency) given the constraints in an operation.

However, nitrogen fertilizer sidedress is currently limited (and thus utilized by a limited number of growers) by ineffective decision support tools that may include labor intensive plant and soil testing and/or equipment mounted sensors that provide little opportunity for an operator to correct fertilizer application (e.g., there is a limited availability of information needed to guide the timing and rate of sidedress application which ultimately justify the equipment necessary to make such applications). Nitrogen fertilizer sidedress may additionally be limited by logistical issues that may hinder adoption due to the inability of farmers, custom applicators, and agricultural retailers to prioritize fields for application and appropriately assign labor and machinery resources.

Currently available sidedress decision support technologies may include significant limitations that hinder confident decision making. For example, image-based methodologies may be limited in instances of persistent cloud cover when relying exclusively on optical satellite data or adverse weather conditions, and/or operational constraints such as availability when relying on aerial vehicles. Additionally, equipment mounted sensors may fail to provide an important critical pre-application checkpoint to address concerns and limit the opportunity for savings when the optimal choice is to forgo sidedress. Handheld nitrogen status sensors may accumulate prohibitive expenses when used for soil and plant tissue analysis if multiple sampling locations are required to represent the crop. Commercial deployment of nitrogen tracking models without in-season calibration has been difficult due to the complex parameterization and error accumulation prior to sidedressing. Thus, the technologies used to guide sidedress applications are implemented sporadically and the potential of sidedress to deliver sustainable nitrogen management at scale has plateaued.

Past solutions include using sensors or models to inform nitrogen sidedress applications. For example, nitrogen use efficiency may be increased when nitrogen sidedress prescriptions are based on multispectral imagery in rainfed corn production. However, sufficient precipitation following sidedress was necessary to ensure success and remote sensing data may be necessary to inform sidedress timing. Equipment mounted sensors may perform real-time correction of a model-recommended total nitrogen rate for late-vegetative sidedress once a decision to apply has been made.

Model based technologies (e.g., Granular and Adapt-N) may sporadically improve nutrient use efficiency (NUE), yield, and/or profitability through variable rate application and nitrogen demand estimations. However, this may be due to sparse weather data and a failure to calibrate with real time data. Management may be optimized through simulations, but models have not been implemented for real-time crop management, integrated with real time data, or used for management recommendations or predictions with forecasted weather.

It may therefore be beneficial to provide method and system that cures the above deficiencies.

### SUMMARY

A system is disclosed, in accordance with one or more embodiments of the present disclosure. In embodiments, the system includes a controller, wherein the controller includes one or more processors configured to execute program instructions stored on memory. In embodiments, the program instructions cause the one or more processors to receive information of a natural environment and management practices for a specified area of a field. In embodiments, the program instructions cause the one or more processors to initiate automated collection of data. In embodiments, the program instructions cause the one or more processors to determine if there is a current or approaching nitrogen demand, wherein the approaching nitrogen demand is characterized by one or more of a difference in forecasted uptake greater than zero or a difference in current uptake greater than zero. In embodiments, the program instructions cause the one or more processors to estimate the current or approaching nitrogen demand and recommending a rate of nitrogen application based on the estimated approaching nitrogen demand. In embodiments, the program instructions cause the one or more processors to calculate at least one nitrogen uptake improvement based on the recommended rate of nitrogen application.

A system is disclosed, in accordance with one or more embodiments of the present disclosure. In embodiments, the system includes nutrient application equipment. In embodiments, the system includes one or more sensors. In embodiments, the system includes a controller communicatively coupled to the one or more sensors and the nutrient application equipment, wherein the controller includes one or more processors configured to execute program instructions stored on memory. In embodiments, the program instructions cause the one or more processors to receive information of a natural environment and management practices for a specified area of a field, wherein the information of the natural environment is received at least partially from the one or more sensors. In embodiments, the program instructions cause the one or more processors to initiate automated collection of data, wherein the automated collection of the data includes automated collection of image data or sensor data by the one or more sensors. In embodiments, the program instructions cause the one or more processors to determine if there is a current or approaching nitrogen demand, wherein the approaching nitrogen demand is characterized by one or more of a difference in forecasted uptake greater than zero or a difference in current uptake greater than zero. In embodiments, the program instructions cause the one or more processors to estimate the current or approaching nitrogen demand and recommending a rate of nitrogen application based on the estimated approaching nitrogen demand. In embodiments, the program instructions cause the one or more processors to calculate at least one nitrogen uptake improvement based on the recommended rate of nitrogen application. In embodiments, the program instructions cause the one or more processors to calculate at least one return on investment based on the recommended rate of nitrogen application and the at least one nitrogen uptake improvement.

A method is disclosed, in accordance with one or more embodiments of the present disclosure. In embodiments, the method includes a step of configuring a system by receiving information of a natural environment and management practices for a specified area of a field. In embodiments, the method includes a step of initiating automated collection of data. In embodiments, the method includes a step of determining if there is a current or approaching nitrogen demand, wherein the approaching nitrogen demand is characterized by one or more of a difference in forecasted uptake greater than zero or a difference in current uptake greater than zero. In embodiments, the method includes a step of estimating the current or approaching nitrogen demand and recommending a rate of nitrogen application based on the estimated approaching nitrogen demand. In embodiments, the method includes a step of calculating at least one nitrogen uptake improvement based on the recommended rate of nitrogen application.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1 illustrates a block diagram of a system, in accordance with one or more embodiments of the present disclosure.

FIG. 2 illustrates a flow diagram of a method, in accordance with one or more embodiments of the present disclosure.

FIG. 3 illustrates a flow diagram of one or more steps of the method, in accordance with one or more embodiments of the present disclosure.

FIG. 4 illustrates a flow diagram of one or more steps of the method, in accordance with one or more embodiments of the present disclosure.

FIG. 5 illustrates a flow diagram of one or more steps of the method, in accordance with one or more embodiments of the present disclosure.

FIG. 6 illustrates a flow diagram of one or more steps of the method, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

A solution for comprehensive nitrogen management and application recommendations includes an ensemble of remote-sensing and mechanistic modeling approaches. This ensemble may allow the model to arrive at optimal nitrogen management decisions with the information available at any point during crop growth. This model may incorporate portions of the business models of growers, agronomists, and fertilizer dealers (e.g., current and expected crop prices, current and expected cost of fertilizer, application costs, and scouting and consulting fees) to evaluate return on investment and related business metrics. Models may further include imagery-driven detection of approaching crop nitrogen demand and subsequent rate recommendations using imagery or model estimates of near-term crop nitrogen demand. Models may be used for estimating the optimal nitrogen amount to apply for the crop during sidedress and/or whether the application of nitrogen will be beneficial.

The model may take into account sensor data and/or optical data when making determinations. Sensor data may include imagery, weather data (e.g., rainfall, growing degree days, humidity, windspeed, hail, or other extreme weather events), irrigation history, soil moisture, soil nitrogen content, spectrometry for leaf color, or the like. Additionally, variables such as soil type, crop type, crop growth stage, current expectations for yield potential, and scouting reports for pest, disease, and weed pressure, could be used in conjunction with the model to adjust or correct nitrogen applications in-season. Optical data may include satellite images, drone images, or the like.

The model may be useful in nitrogen planning and nitrogen plan adjustment.

Nitrogen planning (e.g., forming a nitrogen management plan) may include support for fertilizer procurement decisions, crop budgeting, labor planning, and equipment preparation. The most significant factor affecting the result of a nitrogen management plan is the weather, which may dictate changes to other production practices to adjust to the weather. If farmers and agronomists are able to simulate nitrogen management plans with historically average and anticipated seasonal weather conditions (combined with certainty probabilities), they may better assess how adjustments to the nitrogen management plan (e.g., application rates and timings) could influence crop performance metrics. Ideally, farmers and agronomists could also request a nitrogen management plan with the highest probability of maximizing performance metrics given anticipated weather conditions. The underlying technical capabilities to provide nitrogen management plan optimization may include the same capabilities required for optimal nitrogen sidedress decisions.

Nitrogen plan adjustment may be executed with data-driven in-season nitrogen management decisions to tailor nitrogen applications to crop yield potential and maximize profitability. This may include nitrogen demand detection (e.g., anticipating approaching crop nitrogen demand proactively), nitrogen rate recommendation (e.g., quantifying crop nitrogen to mitigate stress), application justification (e.g., assessing the likely return on investment (ROI) for a nitrogen application), and logistics insights (e.g., prioritizing fields for nitrogen application).

Nitrogen sidedress decisions can be characterized by the following considerations: whether the crop needs supplemental nitrogen to reach its yield potential; if supplemental nitrogen is needed, how much supplemental nitrogen does the crop need; whether there is a likely and sufficient return on investment to justify application of supplemental nitrogen; and the order of applications across multiple fields. These considerations may also take into account what provides the best return on investment potential on each field, given equipment, personnel constraints, and time constraints.

However, these considerations may be challenging to address because of compounding uncertainty of sequential effects on future crop performance and requirements. For example, nitrogen deficiency at the V10 growth stage (e.g., the stage where a corn plant has ten leaves) is likely to reduce yield potential and may reduce nitrogen demand during reproductive growth stages. The optimal nitrogen management decision in this case may be to forego any future nitrogen applications because they are unlikely to increase yield potential. Therefore, when making nitrogen management decisions, it may be important to integrate near-, intermediate-, and long-term nitrogen demand and uptake forecasts along with their accuracy and/or probability to inform optimal decisions.

The system and method described herein may provide guaranteed availability through parallel detection and rate recommendation systems. For example, modelling may be performed based on past data informed by a crop model, such as Decision Support System for Agrotechnology Transfer (DSSAT) model, or an AI-trained field-specific model combined with the traditional approaches (e.g., high nitrogen levels, canary, plots, or imagery). Additionally, the models may be refined such that they may be used at the individual field level.

While the present disclosure is described with reference to the DSSAT model, it should be noted that any other crop model may be used, including a third-party model, a proprietary model, or a field-specific trained model.

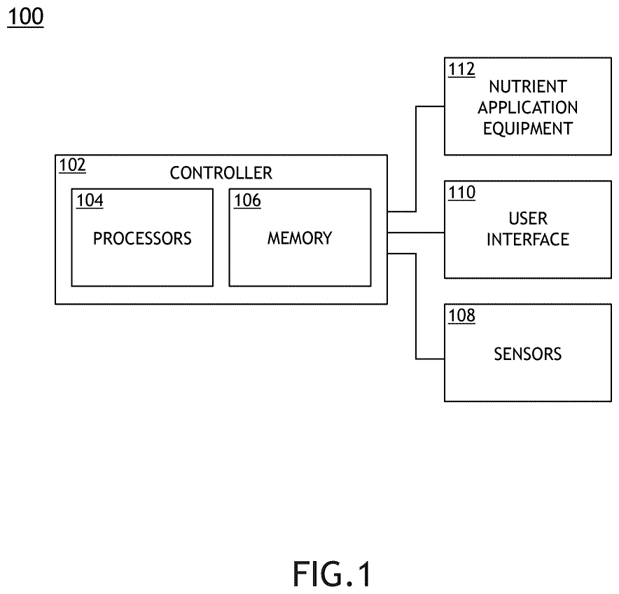

FIG. 1 illustrates a block diagram of a system 100, in accordance with one or more embodiments of the present disclosure.

In embodiments, the system 100 includes a controller 102 communicatively coupled to any components therein. In embodiments, the controller 102 includes one or more processors 104. For example, the one or more processors 104 may be configured to execute a set of program instructions maintained in a memory 106. For example, the program instructions may be configured to cause the processors 104 to execute the steps of the method 200 disclosed herein.

The controller 102 may direct (e.g., through control signals) and/or receive data from any components or sub-systems of the system 100 such as, but not limited to, a set of sensors 108. For example, the sensors 108 may be configured to collect multispectral optical reflectance data. The controller 102 may further be configured to perform any of the various process steps described throughout the present disclosure. In embodiments, the program instructions of the controller 102 may be configured to perform augmented simulant calibration using the multispectral optical reflection data.

The sensors 108 may also be configured to measure in-field soil mineral levels along with the optical reflectance measurements of the crop canopy. Additionally, the sensors 108 may be configured to measure water concentration in the soil.

The sensors 108 may be, but are not limited to, in situ crop sensors, soil sensors, moisture sensors, temperature sensors, humidity sensors, electrochemistry sensors, gas sensors, mechanical sensors, location sensors, light sensors, optical sensors, pH sensors, gas sensors, spectrometry sensors, hail sensors, or wind speed sensors. Additionally, the sensors 108 may include rainfall sensors (e.g., a rain gauge) or imagery (e.g., whether multi spectral or RGB collected from any source, including a satellite, drone, aerial vehicle, ground vehicle, or fixed location).

Additionally, data such as multiple geospatial and geo-independent data structures that characterize relative soil properties, landscape position, crop genetics, management practices, and other variables potentially relevant to any crop production model may be obtained via the sensors 108, manually entered, or may be retrieved from databases.

The system 100 may also include nutrient application equipment 112 (e.g., and/or fertigation equipment or chemigation equipment). For example, the controller 102 and/or the processors 104 therein may be configured to control (e.g., alter) operation of the nutrient application equipment 112 based on the augmented simulant calibration process. For example, the processors 104 may be configured to interpret the information from the sensors 108 and cause the controller 102 to control the nutrient application equipment 112 (e.g., control amounts of chemicals (e.g., fertilizers) or water dispersed through the nutrient application equipment 112).

For example, the nutrient application equipment 112 may include any type of nutrient application equipment, including, but not limited to fertigation equipment, chemigation equipment, sidedress equipment, high-clearance spray applicators, aircraft, drones, irrigation systems, pumps, reservoirs, or the like. The specific output of this system may be a recommendation (e.g., either a fixed- or a variable-rate prescription) that can be uploaded to the nutrient application equipment 112 which then executes the recommendation.

In embodiments, the system 100 may generate one or more control signals, where the control signals are configured to adjust and/or control the nutrient application equipment 112. For example, if, based on the information available, the processors 104 determine that application of nutrients will result in a return on investment above a selected threshold, and that determination is made with sufficient certainty (e.g., in accordance with steps of method 200), the controller 102 may be configured to control the nutrient application equipment 112 to cause an application of nutrients. Additionally, if the return on investment is not above the selected threshold, or the return on investment does not have sufficient certainty, the controller 102 may be configured to control the nutrient application equipment 112 to cause no application of nutrients, or cancel a previously scheduled application of nutrients.

In embodiments, a user may review return on investment and/or certainty determinations made by the processor 104. If the user is satisfied with the return on investment and certainty, the user may cause the nutrient application equipment 112 to apply nutrients. However, if the user is not satisfied with the return on investment and/or certainty, the user may cause the nutrient application equipment 112 to not apply nutrients.

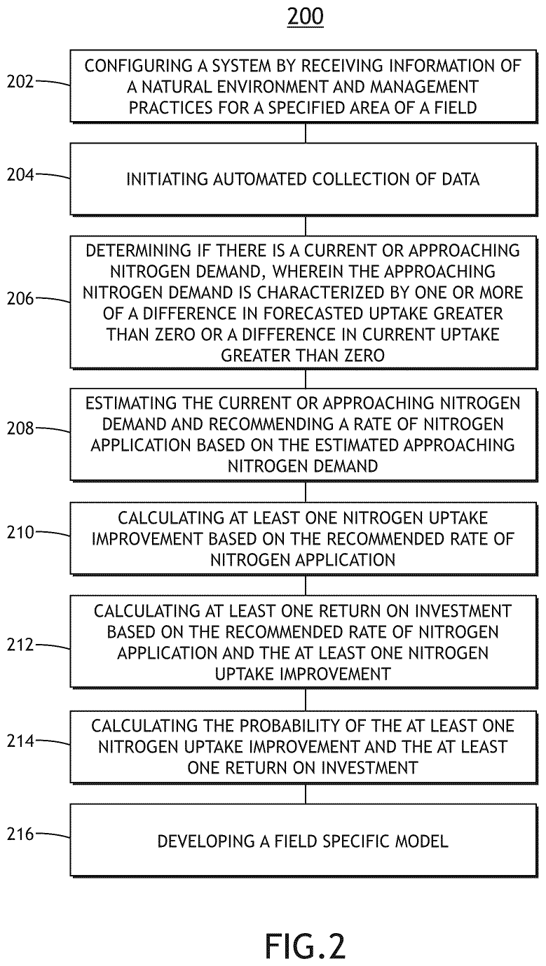

FIG. 2 illustrates a flow diagram of a method 200, in accordance with one or more embodiments of the present disclosure. The method may be performed by system 100 and one or more steps of method 200 may be executed by the controller 102 of system 100. Applicant notes, however, that the embodiments and enabling technologies described previously herein in the context of the system 100 should be interpreted to extend to the method 200. It is further noted, however, that the method 200 is not limited to the architecture of the system 100.

The method 200 may include the input of sensor data which can come from any sensor (e.g., imagery, weather data, including but not limited to rainfall, growing degree days, humidity, windspeed, hail or other extreme weather events, irrigation history, soil moisture, soil nitrogen content, or spectrometry for leaf color) capable of measuring crop or soil response to nitrogen. Additionally, the method 200 may include the input of optical imagery. The sensor data and/or optical imagery may be obtained from in situ crop sensors, soil sensors, moisture sensors, temperature sensors, humidity sensors, electrochemistry sensors, gas sensors, mechanical sensors, location sensors, light sensors, optical sensors, pH sensors, gas sensors, optical sensors, spectrometry sensors, hail sensors, wind speed sensors, or optical imagery sources (e.g., cameras mounted on satellite, cello phone cameras manned or unmanned aerial vehicle, ground vehicles, or carried into the field by a person (e.g., a crop scout)). The optical imagery may be provided in any form, including, but not limited to red, green, and blue (RGB) imagery, multi-or hyper-spectral imagery, or thermal sensor imagery.

In embodiments, the method 200 includes a step 202 of configuring a system by receiving information of a natural environment and management practices for a specified area of a field (e.g., up to, or including an entire field). For example, the processors may receive the information of the natural environment and management practices. Configuring the system may include collecting information about variables such as, but not limited to, the field, crops, and intended practices and inputting the information into the model.

For example, configuring the system may include specifying a geospatial boundary (e.g., the boundary of a field, multiple fields, or a subset of a field) (e.g., by using maps, satellites, parcel descriptions, user inputs, and/or remote databases). By way of another example, configuring the system may include collecting available or anticipated crop information (e.g., crop type, crop hybrid, crop variety, maturation data (e.g., heat units to critical growth stages), or phenotypic performance data). Crop information may be provided by user input, third party databases that are remotely accessed, or provided by a seed supplier.

Other data may include economic data (e.g., current and/or anticipated crop price at harvest, yield goals, cost of fertilizer, cost of fertilizer application, or seed cost), terrain (e.g., slope and orientation (e.g. northwest) of the slope), level of crop residue, or crops that were planted in the field during prior growing seasons. Further data may include biological activity, microbial activity soil reports, plant sap analyses, tissue analyses, pest, weed, and disease detection/reports, pest, weed, and disease forecasts, and spatial probability estimates. Other product applications or farming practices may also be considered (e.g., biologicals, foliar sprays, herbicides, insecticides, fungicides, other fertilizers, tillage, cover crops, manure applications, grazing practices, or compaction).

By way of another example, configuring the system may include collecting available or anticipated management information. The management information may be provided by a user or obtained from another source, such as, but not limited to a database. The database may be a database compiled by a user, a third-party database accessed remotely (e.g., over internet or cellular data), or a best practices database. The management information may include application information (e.g., the method, rate, composition, or timing of applications of water, fertilizer, or chemicals), tillage information (e.g., method, depth, or timing of tillage), planting information (e.g., depth, population, or timing of planting), or harvest information (e.g., timing of harvest).

By way of another example, configuring the system may include collecting soil information (e.g., physical properties of the soil, chemical properties of the soil, or biological properties of the soil). Soil information may be collected from sensors (e.g., any of the sensors previously disclosed herein), user inputs, or databases (e.g., databases including representative soil information for an area).

By way of another example, configuring the system may include collecting information such as historical imagery (e.g., of the field), historical crop production data (e.g., yields), historical management data, historical weather data, or forecasted weather data (e.g., for the current growing season). Historical imagery may be obtained from a database created by the user to store historical images of fields, provided by the user, or obtained from a third-party data base storing historical images of fields. Other historical data or forecasted data may be entered by a user, obtained from past or present weather forecasts or records, obtained from a third-party database, or obtained from a database of the user's records.

By way of another example, configuring the system may include defining any operating limits that the field or crops may be subjected to. For example, the operating limits may include limits on water application, limits on nutrient application, time limits (e.g., days left in a growing season), or crop-specific limits (e.g., maximum tolerances for particular crops). These may be defined by a user, or obtained from a third-party database. Other operating limits may include equipment availability, personnel availability, location and/or distance of equipment relative to a field, demands of other fields and their proximity, budgetary constraints, sustainability limitations (e.g., carbon limits or similar limits), machinery application capabilities (e.g. turndown or range), planting date range, harvest date range, or intended crop use (e.g., biorefining or livestock feed).

In embodiments, the method 200 includes a step 204 of initiating automated collection of data. For example, the processors may receive information from the sensors, databases, data input by the user, field histories, or the like. Automated data collection may come from sensors, weather forecasts, or updates to databases.

For example, initiating automated collection of data may include collection data via sensors from various areas of a field. By way of another example, initiating automated collection of data may include activating data input listeners for crop, management, and/or soil information. By way of another example, initiating automated collection of data may include activating model run listeners. By way of another example, initiating automated collection of data may include running the model at the current date based on initial conditions (e.g., weather and soil conditions).

Additionally, the system may automated collection of data may start due to a request from an external system (e.g., enrollment from John Deere Operations Center may spark the system to begin running), a certain machine action in the field, or a seed or fertilizer sale.

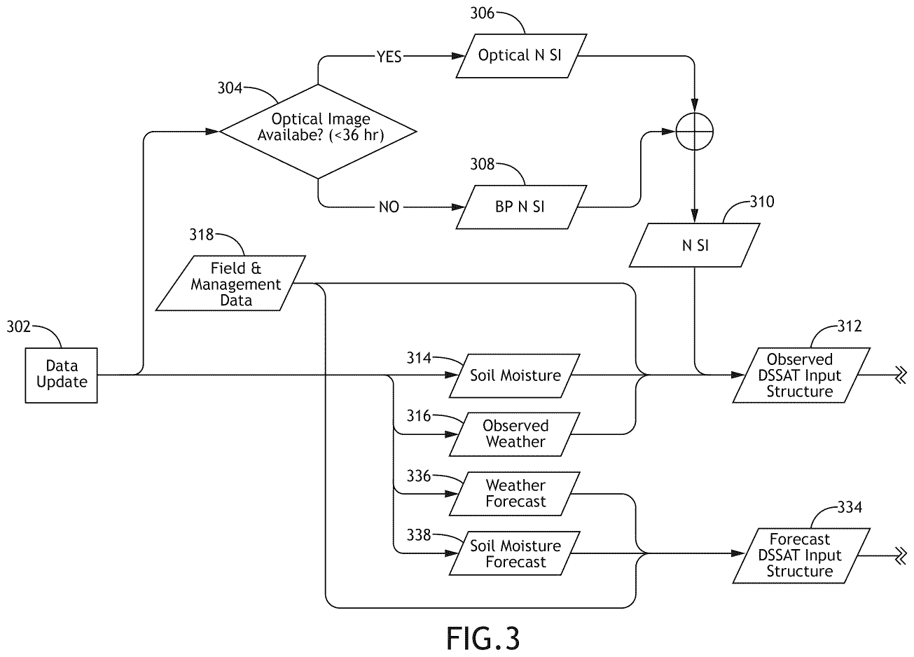

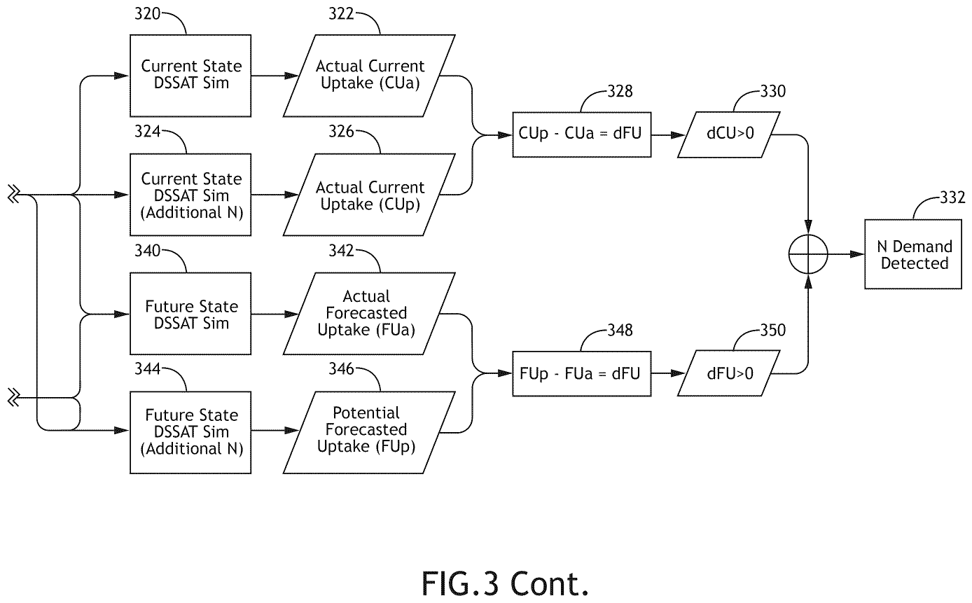

FIG. 3 illustrates a flow diagram of one or more steps (e.g., step 206) of the method 200, in accordance with one or more embodiments of the present disclosure.

In embodiments, the method 200 includes a step 206 of determining if there is a current or approaching nitrogen demand, wherein the approaching nitrogen demand is characterized by one or more of a difference in forecasted uptake greater than zero or a difference in current uptake greater than zero. For example, the processor may execute one or more simulations and/or calculations based on current, historical, and predicted conditions to determine if there is an approaching nitrogen demand. It is noted that an approaching nitrogen demand may correspond to nitrogen demand within 0-3 days.

Uptake is the process by which plants absorb nutrients (e.g., nitrogen) through their roots. A higher uptake indicates the plants are absorbing additional nutrients from the soil. Factors that affect uptake may include, but are not limited to, temperature, oxygen content, rainfall, soil moisture, acidity, alkalinity, and salinity.

Estimating approaching nitrogen demand may be achieved by detecting a divergence in sufficiency values in calibrated optical satellite imagery. This technique may transform the optical satellite imagery into a nitrogen sufficiency index (SI) using three-point calibration. Calibration may be achieved with either paired plot calibration or augmented simulant calibration techniques. These techniques are described in U.S. patent application Ser. No. 18/790,919, entitled “Augmented Simulant Calibration of Geospatial Data for Property Quantification,” and filed on Jul. 31, 2024, which is herein incorporated by reference in its entirety. These techniques may use sufficiency index imagery to determine crop nitrogen status spatially and/or temporally. Divergence in crop nitrogen sufficiency away from the optimal sufficiency may trigger a justified application of nutrients.

The decision on whether application of nutrients is justified may be based on the priority justification approach for the Guaranteed Availability Decision Support System for Nitrogen (GADSS-N) decision support system. However, there are flaws to this technique that may need to be addressed. Optical imagery may not be consistently available (e.g., due to cloud cover), or it may be negatively impacted by soil background reflectance prior to crop canopy development, making it less effective for early sidedress applications, as well as detection of nitrogen demand following early vegetative leaching (e.g., the loss of water-soluble nutrients) events. Furthermore, divergence monitoring techniques with simulant calibration may be exposed to contamination by non-nitrogen factors (e.g., water stress, disease, pest pressure, weed pressure, or uneven emergence).

To address these flaws and ensure constantly available nitrogen demand insights, a parallel nitrogen demand detection framework may be implemented to justify sidedress application. The nitrogen demand detection technique integrates guaranteed availability biomass proxy (BP) data (e.g., satellite-based data that estimates the relative amount of aboveground crop biomass) with the Decision Support System for Agrotechnology Transfer (DSSAT) model, which includes crop and soil nutrient dynamics modules that have been academically validated. Biomass proxy data may alternatively be obtained from a third-party database, such as a satellite imagery provider, that is remotely accessed.

The DSSAT model is described in Hoogenboom, G., et al, 2019, The DSSAT Crop Modeling Ecosystem, in: Advances in Crop Modeling for a Sustainable Agriculture, pp.173-216, which is incorporated herein by reference in its entirety. However, the nitrogen tracking model (e.g., the DSSAT model) may be plagued by rapid propagation of uncertainty. The rapid propagation of uncertainty may be cured by applying forcing, which will result in more accurate outputs from the DSSAT. The rapid propagation of uncertainty is disclosed in Oenema, O., Kros, H., and de Vries, W., 2003, Approaches and Uncertainties in Nutrient Budgets: Implications for Nutrient Management and Environmental Policies, in: European Journal of Agronomy, 20(1-2), pp.3-16; Miller, C. M., Waterhouse, H., Harter, T., Fadel, J. G. and Meyer, D., 2020, Quantifying the Uncertainty in Nitrogen Application and Groundwater Nitrate Leaching in Manure Based Cropping Systems, in: Agricultural Systems, 184, p.102877; and Oenema, O., Kros, H. and de Vries, W., 2003, Approaches and Uncertainties in Nutrient Budgets: Implications for Nutrient Management and Environmental Policies, in: European Journal of Agronomy, 20(1-2), pp.3-16, which are all herein incorporated by reference in their entirety.

Any soil moisture sensor may be used to force soil moisture dynamics. However, it may be beneficial to use daily soil moisture content, withdrawals, and between-layer infiltration quantified from synthetic aperture radar data for various soil depth layers (e.g., 5-, 15-, 30-, 60-, and 100-centimeter (cm) soil depth layers). Because DSSAT uses these values at similar depths to estimate nitrogen fixation, mineralization, nitrification, denitrification, volatilization, immobilization, leaching, and crop nitrogen uptake, forcing these values to measured observations may improve model output. Additionally, nitrogen sufficiency index values are used to force nitrogen stress index values in DSSAT.

A biomass proxy-based nitrogen stress index measurement that correlates with nitrogen sufficiency index measurements produced from optical satellite imagery may be used. Biomass proxy-based nitrogen stress index values may be applied as daily forcing values on DSSAT nitrogen stress index output to further improve the accuracy of estimated nitrogen uptake and forecasted nitrogen demand. The reinforcement (e.g., observation updates) may be carried out based on well-established physiological and empirical studies. The physiological studies are disclosed in Plénet, D. and Lemaire, G., 1999, Relationships Between Dynamics of Nitrogen Uptake and Dry Matter Accumulation in Maize Crops. Determination of Critical N Concentration, in: Plant and Soil, 216, pp.65-82 and Lemaire, G. and Ciampitti, I., 2020, Crop Mass and N Status as Prerequisite Covariables for Unraveling Nitrogen Use Efficiency Across Genotype-by-Environment-by-Management Scenarios: A Review, in: Plants, 9(10), p.1309, which are both incorporated herein by reference in their entirety. Additionally, the empirical studies are disclosed in Sharifi, A., 2020, Using Sentinel-2 Data to Predict Nitrogen Uptake in Maize Crop, in: IEEE Journal of Selected Topics in Applied Earth Observations and Remote Sensing, 13, pp.2656-2662, which is incorporated herein by reference in its entirety.

Initial conditions for DSSAT may include nitrogen application records from the grower and any other soil information available, such as soil sample data or soil data obtained from sensors, or soil data from a remote database such as the Soil Survey Geographic Database from the USDA's Natural Resources Conversation Service (SSURGO). As a result, this approach of model forcing using observational data helps to further correct aspects of nitrogen availability insufficiently represented in DSSAT such as soil biology, manure conversion, cover crop degradation, and the like.

To determine the relative crop nitrogen uptake versus potential nitrogen uptake, whether due to nitrogen loss or insufficient nitrogen application, DSSAT is used to estimate current and future, actual and potential crop nitrogen uptake.

In order to determine whether or not there is a nitrogen demand, data updates 302 may be initiated. Data updates 302 may include a determination of whether or not optical imagery is available (e.g., box 304) within a set time period (e.g., 36 hours). If optical imagery is available, an optical nitrogen sufficiency index 306 may be generated. However, if no optical imagery is available, a biomass proxy nitrogen sufficiency index 308 may be generated. Depending on whether or not optical imagery is available, the one of the optical nitrogen sufficiency index 306 or the biomass proxy nitrogen sufficiency index 308 may be used as the nitrogen sufficiency index 310. It is noted that the nitrogen sufficiency index 310 may be inversely correlated to a nitrogen stress index.

An observed DSSAT input structure 312 may receive the nitrogen sufficiency index 310. Additionally, other data may be supplied to the observed DSSAT input structure 312. For example, the observed DSSAT input structure 312 may receive soil moisture 314, observed weather 316, field and management data 318, in addition to the nitrogen sufficiency index 310. This data may be from user input, sensors located in the field, databases made by the user, or third-party databases that are remotely accessed. The observed DSSAT input structure 312 may supply the data to a current state DSSAT simulation 320 to determine the actual current uptake 322 (CUa). The observed DSSAT input structure may additionally supply the data to a current state DSSAT simulation with additional nitrogen 324 to determine the potential current uptake 326 (CUp). The actual current uptake 322 to reflect the current nitrogen uptake, while the potential current uptake 326 may reflect the uptake that would be seen if more nitrogen was added. The difference between the potential current uptake 326 and the actual current uptake 322 may be calculated (e.g., box 328) to find the difference in current uptake 330 (dCU). If the difference in current uptake is greater than zero, then a nitrogen demand 332 has been detected.

The actual current uptake 322 may be characterized as a complete observed forcing without additional nitrogen, while the potential current uptake 326 may be characterized as soil moisture forcing with additional nitrogen application.

Additionally, a forecast DSSAT input structure 334 is may receive data. For example, the forecast DSSAT input structure 334 may receive data including weather forecasts 336, soil moisture forecasts 338, and field and management data 318. This data may be from user input, sensors located in the field, databases made by the user, or third-party databases that are remotely accessed. The forecast DSSAT input structure 334 may supply the data to a future state DSSAT simulation 340 to determine the actual forecasted uptake 342 (FUa). The forecast DSSAT input structure may additionally supply the data to a future state DSSAT simulation with additional nitrogen 344 to determine the potential forecasted uptake 346 (FUp). The difference between the potential forecasted uptake 346 and the actual forecasted uptake 342 is then calculated (e.g., box 348) to find the difference in forecasted uptake 350 (dFU). If the difference in forecasted uptake 350 is greater than zero, then a nitrogen demand 332 has been detected.

The actual forecasted uptake 342 may be characterized as a complete observed and forecasted forcing without additional nitrogen, while the potential forecasted uptake 346 may be characterized as soil moisture forecasted forcing with additional nitrogen application.

Additional nitrogen stress index forcing based on remote sensing data (e.g., data obtained from sensors in the field) may be determined for the forecast interval using a backward calibration technique. Pairwise comparison of actual and potential nitrogen uptake in the current and future time horizon may be used to determine if there is current or approaching crop nitrogen demand with guaranteed availability. If in either the current or future time horizon potential crop nitrogen uptake is higher than actual crop nitrogen uptake, the user will be informed that the crop demands additional nitrogen and an application may be warranted.

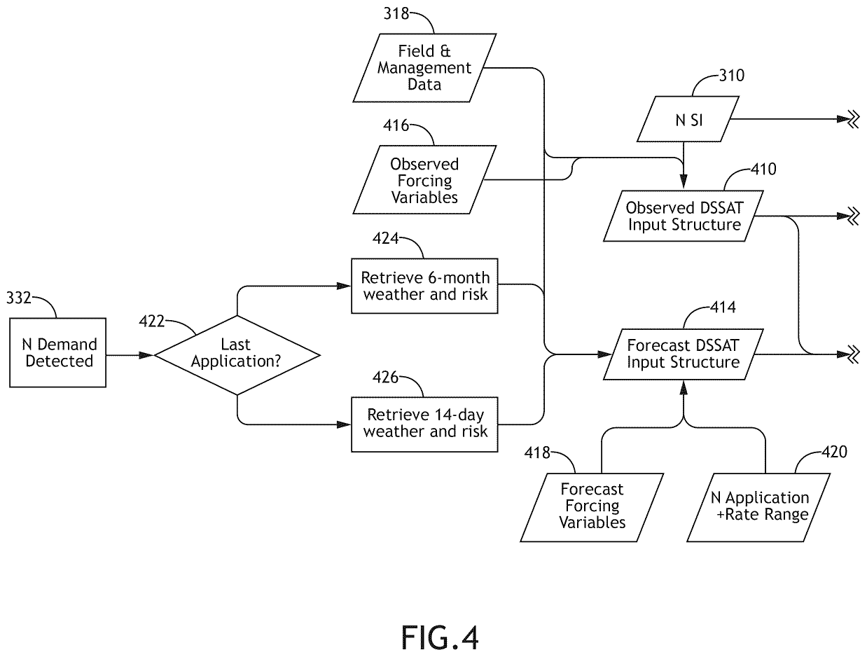

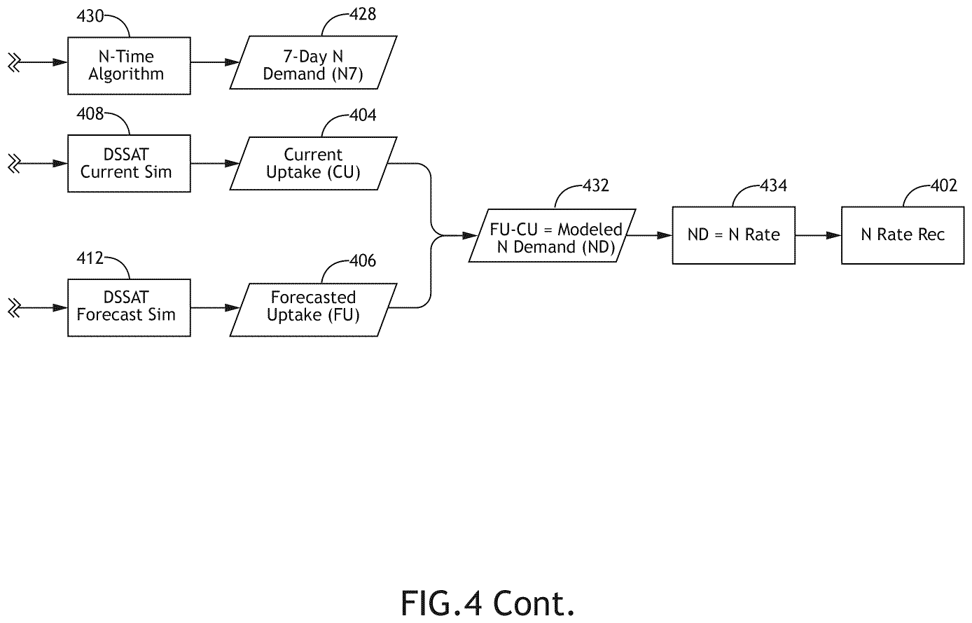

FIG. 4 illustrates a flow diagram of one or more steps (e.g., step 208) of the method 200, in accordance with one or more embodiments of the present disclosure.

In embodiments, the method 200 includes a step 208 of estimating the current or approaching nitrogen demand 332 and recommending a rate of nitrogen application 402 based on the estimated approaching nitrogen demand 332. For example, the processors may estimate the approaching nitrogen demand and recommend a rate of nitrogen application(s) 402 by executing one or more simulations and/or calculations based on current, historical, and predicted conditions to determine if there is an approaching nitrogen demand 332.

The temporal variation of the nitrogen sufficiency index 310 may be used to determine the optimal rate of nitrogen application 402 to satisfy approaching crop nitrogen demand 332. A rate of nitrogen application 402 may be determined for the entire field, for sub-field zones, or individual image pixels. While these rates of nitrogen application 402 predictions are highly reliable, they may require optical image availability and may only account for up to 14 days of crop nitrogen demand 332. In geographies where clouds are more prevalent (e.g., where rainfed crop production is common) this may pose a challenge due to time and application limitations due to crop height and machinery constraints. These flaws may be addressed by integration of a crop and soil nitrogen dynamics model to provide near-term rate recommendation redundancy and estimate crop nitrogen demand 332 past the forecasted 14 days of nitrogen demand 332.

In order to determine the rate of nitrogen application 402, multiple DSSAT simulations may be performed to determine current uptake 404 (CU) and a forecasted uptake 406 (FU). For example, a DSSAT current simulation 408 may be performed based on an observed DSSAT input structure 410 to generate the current uptake 404. By way of another example, a DSSAT forecast simulation 412 may be performed based on a forecast DSSAT input structure 414 to generate the forecasted uptake 406.

The observed DSSAT input structure 410 may receive the field and management data 318, observed forcing variables 416 (e.g., soil moisture 314, observed weather 316, or the like), and the nitrogen sufficiency index 310. These pieces of information may be supplied to the DSSAT current simulation 408 in order to generate the current uptake 404. It is noted that while the current uptake 404 may be the same as the actual current uptake 322 generated with regards to FIG. 3, different simulation parameters may be used, resulting in a difference between the current uptake 404 and the actual current uptake 322.

The forecast DSSAT input structure 414 may receive the field and management data 318, forecast forcing variables 418 (e.g., weather forecasts 336, soil moisture forecasts 338, or the like), and nitrogen application information and rate range 420. Additionally, a determination of the last nitrogen application may be made (e.g., box 422). Based on when the last nitrogen application may be made, the forecast DSSAT input structure 414 may receive a 6-month weather and risk 424 and/or a 14-day weather and risk forecast 426. These pieces of information may be supplied to the DSSAT forecast simulation 412 in order to generate the forecasted uptake 406. It is noted that while the forecasted uptake 406 may be the same as the actual forecasted uptake 342 generated with regards to FIG. 3, different simulation parameters may be used, resulting in a difference between the forecasted uptake 406 and the actual forecasted uptake 342.

If optical imagery is available, it may be used to determine the optimal application rate to satisfy an estimated intermediate term crop nitrogen demand (e.g., nitrogen demand 332). The intermediate term crop nitrogen demand may then be used to determine a near-term crop nitrogen demand 428 (N7) (e.g., by using an appropriate algorithm, such as the N-Time algorithm 430 provided by Sentinel Fertigation). The near-term crop nitrogen demand 428 may additionally set the minimum rate of additional nitrogen application at which forecast simulations of additional applied nitrogen begin. Simulations may quantify the impact of additional applied nitrogen greater than or equal to the near-term crop nitrogen demand 428.

The nitrogen demand 332 may additionally act as a forcing condition in the DSSAT current simulation 408 and/or the DSSAT forecast simulation 412, which will be run with weather forecasts under additional initial and output forcing conditions (e.g., field and management data 318, observed forcing variables 416, forecast forcing variables 418, and nitrogen application information and rate range 420) to determine crop nitrogen demand beyond what optical imagery has detected. It should be noted that weather forecasts may integrate sub-seasonal to long-range weather forecasts. It is noted that the near-term crop nitrogen demand 428 may correspond to nitrogen demand at between 3 and 14 days (e.g., 7 days). It is further noted that the intermediate term crop nitrogen demand may correspond to nitrogen demand at between 7 and 21 days (e.g., 14 days).

A modeled nitrogen demand 432 (ND) may be calculated by the difference between the forecasted uptake 406 and the current uptake 404 (ND=FU-CU). In instances where optical imagery is available, the rate of nitrogen application 402 may be determined by adding the near-term crop nitrogen demand 428 to the difference between the modeled nitrogen demand 432 and the near-term crop nitrogen demand 428 to obtain the recommended rate of nitrogen application 402 (N Rate) (N Rate=N7+(ND-N7)) (e.g., box 434). Therefore, the recommended rate of nitrogen application 402 may be the near-term crop nitrogen demand 428. Therefore, the formula may be simplified to such that the formula is N Rate=ND from the simulation where the lower bound on the modeled nitrogen demand 432 is the near-term crop nitrogen demand 428.

Additionally, where the modeled nitrogen demand 432 is less than the near-term crop nitrogen demand 428, the nitrogen rate may be characterized as the near-term crop nitrogen demand 428. However, if the modeled nitrogen demand 432 is greater than the near-term crop nitrogen demand 428, the recommended rate of nitrogen application 402 may be characterized as the modeled nitrogen demand 432.

The recommended rate of nitrogen application 402 to be selected may also be influenced by when the nitrogen application is being made. If the user is making their last application the higher of the near-term crop nitrogen demand 428 and the modeled nitrogen demand 432 may be used. If the user is making an application and plans to re-evaluate in a week, only the modeled nitrogen demand 432 may be used. If the user plans to apply again but after a period of time, the higher of the near-term crop nitrogen demand 428 and the modeled nitrogen demand 432 may be used.

If optical imagery is unavailable, the DSSAT forecast simulation 412 may execute with a 14-day weather and risk forecast 426 under forced conditions to produce a intermediate term crop nitrogen demand forecast. If the rate recommend is for the last application to the crop or there will be more than 14 days prior to the next application, the DSSAT forecast simulation 412 will be run with a daily seasonal forecast up to the next application or through crop maturity with forced initial conditions to quantify crop nitrogen demand between 14 days and either the next application date or crop maturity. The final nitrogen rate recommendation for the application may result from the sum of the intermediate term crop nitrogen demand and beyond-14-day crop nitrogen demand. Thus, if nitrogen will be applied for the last time to the crop within an intermediate term (e.g., 14 days), it will incorporate all intermediate term nitrogen demand and long-term nitrogen demand.

It should be noted that the approaching nitrogen demand, the near-term crop nitrogen demand, the intermediate term crop nitrogen demand, and the long-term crop nitrogen demand should only be interpreted as timeframes relative when compared to each other. In this way, the long-term crop nitrogen demand may be a greater timeframe than the intermediate term crop nitrogen demand, the intermediate term crop nitrogen demand may be a greater timeframe than the near-term crop nitrogen demand, and the near-term crop nitrogen demand may be a greater timeframe than the approaching nitrogen demand. Additionally, each of the approaching nitrogen demand, the near-term crop nitrogen demand, the intermediate term crop nitrogen demand, and the long-term crop nitrogen demand may take into account any amount of days, or any other time periods.

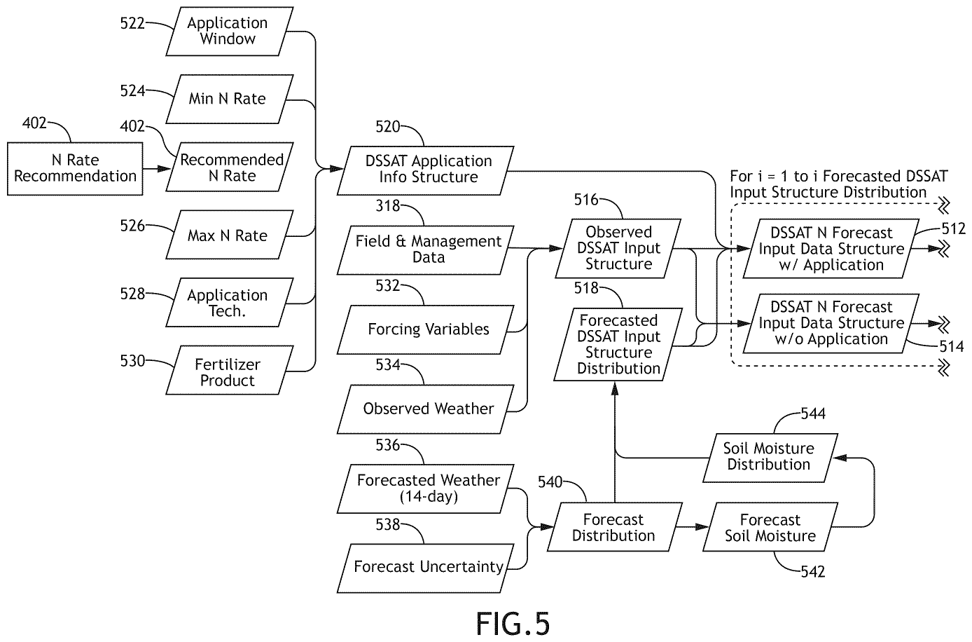

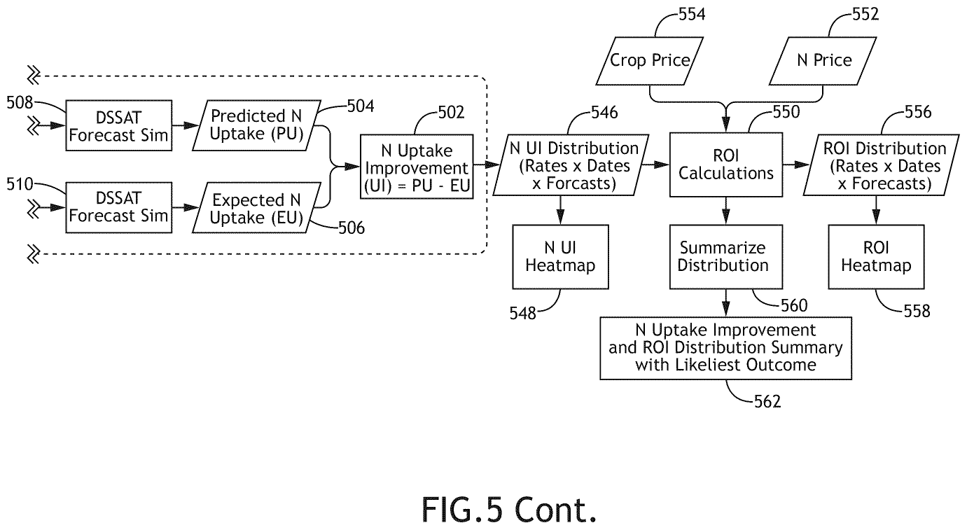

FIG. 5 illustrates a flow diagram of one or more steps (e.g., step 210, step 212, and step 214) of the method 200, in accordance with one or more embodiments of the present disclosure.

In embodiments, the method 200 includes a step 210 of calculating at least one nitrogen uptake improvement 502 based on the recommended rate of nitrogen application 402. For example, the processors may use the recommended rate of nitrogen application 402 to determine if, and to what degree, carrying out that rate of nitrogen application would result in a nitrogen uptake improvement 502.

The predicted nitrogen uptake improvement 502 (UI) may be calculated as the difference between the predicted nitrogen uptake 504 (PU) (e.g., the nitrogen uptake predicted with application of the recommended nitrogen rate) and the expected nitrogen uptake 506 (EU) (e.g., the expected nitrogen uptake without application of the recommended nitrogen rate).

A predicted DSSAT forecast simulation 508 may generate the predicted nitrogen uptake 504. Additionally, an expected DSSAT forecast simulation 510 may generate the expected nitrogen uptake 506. The predicted DSSAT forecast simulation 508 may use data stored in a DSSAT nitrogen forecast input data structure with nitrogen application 512. The expected DSSAT forecast simulation 510 may use data stored in a DSSAT nitrogen forecast input data structure without nitrogen application 514.

Both the DSSAT nitrogen forecast input data structure with nitrogen application 512 and the DSSAT nitrogen forecast input data structure without nitrogen application 514 may include a combination of data from an observed DSSAT input structure 516 and a forecasted DSSAT input structure 518. However, the DSSAT nitrogen forecast input data structure with nitrogen application 512 may include additional information from a DSSAT application information structure 520.

The DSSAT application information structure 520 may include data such as, but not limited to, application window 522, minimum nitrogen rate 524, maximum nitrogen rate 526, application technology 528 (e.g., the type of nutrient application equipment), and fertilizer product 530. The 520 may also include the recommended rate of nitrogen application 402, which may be a value between the minimum nitrogen rate 524 and the maximum nitrogen rate 526.

The observed DSSAT input structure 516 may include data such as, but not limited to, field and management data 318, forcing variables 532 (e.g., the same or different forcing variables than the observed forcing variables 416), and observed weather 534. The forecasted DSSAT input structure 518 may include data such as, but not limited to, forecasted weather 536 (e.g., a 14-day forecast), forecast uncertainty 538, forecast distribution 540, forecast soil moisture 542, and soil moisture distribution 544. The data stored in the observed DSSAT input structure 516, the forecasted DSSAT input structure 518, and the DSSAT application information structure 520 may be from user input, sensors located in the field, databases made by the user, or third-party databases that are remotely accessed.

The predicted DSSAT forecast simulation 508 may be performed across a range of nitrogen application rates and weather forecasts for each day in a user-specified application window and a user-specified application technique and product. The primary nitrogen rate used in the predicted DSSAT forecast simulation 508 may correlate to the recommended rate of nitrogen application 402 (e.g., in step 208) to satisfy the crop nitrogen demand under the anticipated conditions. However, additional nitrogen rates may be included in the predicted DSSAT forecast simulation 508. These rates may result from user input and range from the minimum nitrogen rate 524 (e.g., 15 pounds of nitrogen per acre) to the maximum nitrogen rate 526 (e.g., 150 pounds of nitrogen per acre). These additional nitrogen rates may be factored into the predicted DSSAT forecast simulation 508 at specified increments (e.g., increments of 5 pounds of nitrogen per acre).

A nitrogen uptake improvement distribution 546 may be created. The nitrogen uptake improvement distribution 546 may take into account the rates of nitrogen application, dates of nitrogen application, and forecasts. Using the nitrogen uptake improvement distribution 546, a nitrogen uptake improvement heatmap 548 may be formed. The nitrogen uptake improvement heatmap 548 may illustrate areas (e.g., fields or portions of fields) that may exhibit the highest nitrogen uptake improvement.

In embodiments, the method 200 includes a step 212 of calculating at least one return on investment based on the recommended rate of nitrogen application 402 and the at least one nitrogen uptake improvement 502. For example, the processors may perform return on investment calculations 550 based on the cost to add additional nitrogen to the field and the improvement the added nitrogen would have on crop yield. The return on investment calculations may take account for at least the nitrogen price 552 (e.g., price per pound of fertilizer and application costs) and the crop price 554.

Even though a nitrogen demand may be detected and a nontrivial nitrogen deficiency may be estimated (e.g., a rate of nitrogen application 402 has been recommended), intervention via sidedress application may only be warranted if the application of nitrogen will increase nitrogen uptake enough to generate a revenue return sufficient to justify the cost of nitrogen application (e.g., a breakeven point). For example, if the total cost (e.g., known total cost, estimated total cost, or partially estimated total cost) for application exceeds the value added to the crops by performing the application, application may not be performed. This analysis may be performed for various locations (e.g., parts of fields, entire fields, or multiple fields). The associated costs may be manually entered by a user or automatically obtained from one or more third-party databases.

As an illustration, fertilizer may cost $0.60 per pound of nitrogen and applications costs (e.g., fuel, labor, equipment) may be $8.50 per acre. This means that a 50 pounds of nitrogen per acre sidedress application would cost $38.50 per acre. To break even, the sidedress application must increase revenue by at least $38.50 per acre. Assuming corn costs $4.00 per bushel, an increase in yield of approximately 10 bushels per acre would be required to break even.

Based on the nitrogen uptake improvement distribution 546 and the return on investment calculations 550, a return on investment distribution 556 may be formed. The return on investment distribution may provide a return on investment heatmap 558 (e.g., a map showing areas in fields where return on investment would be highest).

The simplest form of the output may show only return on investment, nitrogen uptake improvement, and probability of the estimated outcome by date at an application rate equal to the rate recommended to satisfy anticipated crop nitrogen demand. The probability may depend on the uncertainty of variables used during simulations. More complex output views will show return on investment heatmaps 558, nitrogen uptake improvement 502, nitrogen uptake improvement heatmap 548, and certainty as a function of application date and nitrogen application rate. These forecast outputs may help users decide whether an application is likely enough to achieve their desired return on investment based on their own risk tolerance, and further determine what nitrogen rate is most appropriate for them given their risk tolerance and desired return on investment.

Further, a summarized distributions 560 of all nitrogen uptake improvement distributions 546 and return on investment distributions 556 may illustrate all possible outcomes. Additionally, a simpler output may only show the likeliest outcome 562.

The return on investment forecast output may be generated for multiple fields and used to inform a logistics report that helps users determine which fields to prioritize for application of additional nitrogen. To generate this logistics report, users may identify their application decision (e.g., apply nitrogen or do not apply nitrogen) and average nitrogen rate for each field. Given these decisions, a report may be generated ranking fields in priority order and showing the optimal application date to maximize return at the chosen nitrogen rate.

In embodiments, the method 200 includes a step 214 of calculating a probability of the at least one nitrogen uptake improvement and the at least one return on investment. For example, the processors may calculate a probability (e.g., certainty) based on numerous factors relating to field condition.

Factors that may affect how much uptake occurs, when it occurs, and with what certainty it occurs include application specific variables (e.g., timing, rate, product, technique, and weather). For example, nitrogen fertilizer applied via sidedress in rainfed crop production systems without sufficient subsequent precipitation to incorporate nitrogen and make it available to the crop is subject to significant losses (e.g., volatilization) and may not increase nitrogen uptake significantly. Therefore, nitrogen uptake improvement certainty is an important factor for accurate nitrogen sidedress decisions.

Each uptake improvement and return on investment may be accompanied by the probability of achieving the predicted outcome.

In embodiments, the method 200 includes a step 216 of developing a field specific model. For example, the field specific model may be generated by the one or more processors.

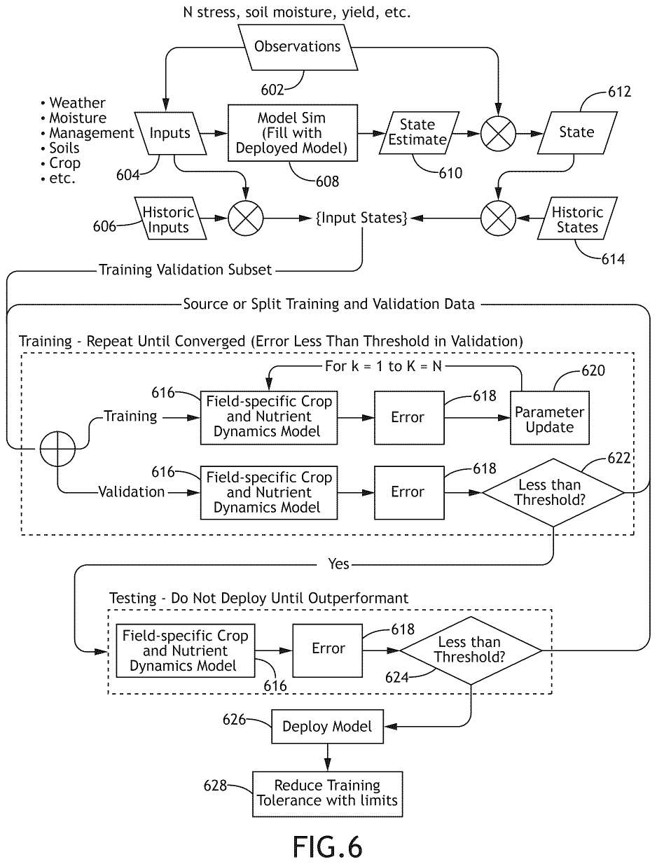

FIG. 6 illustrates a flow diagram of one or more steps (e.g., step 216) of the method 200, in accordance with one or more embodiments of the present disclosure. A field specific model (e.g., a digital twin) may be trained on mixed and/or forced DSSAT simulations, as well as observational data. This may allow each field to develop its own model (e.g., each field has a model specific to that particular field).

Additionally, each field specific model may inform and improve the global model, and at the same time use the global model to improve field specific modelling. This may be accomplished by fusing artificial intelligence (AI) and mechanistic models at both field, regional, and global levels, while also allowing all three levels to inform each other to further improve and accelerate model improvements via machine learning.

In embodiments, a model to be trained for individual fields may receive various data inputs. For example, the model may receive observations 602 (e.g., nitrogen stress or yield), inputs 604 and historic inputs 606 (e.g., weather, moisture, management practices, soil type, or crop type), previous model simulations 608, state estimates 610, states 612, and historic states 614.

Developing a field specific model 616 may include training the model after the model has received the various data inputs. Data from the field specific model 616 may be checked for error 618 and receive a parameter update 620. Upon updating the parameter, validation of the model may be attempted by determining if the model with the updated parameter produces data less than a threshold (e.g., box 622). If the error 618 is less than the threshold, the field specific model 616 may progress to testing. If the error 618 is greater than the threshold, the training of the field specific model 616 may continue. In order to train the field specific model 616, inputs 604 and state estimates 610 (e.g., the output of DSSAT simulations) may be compared against the actual state 612 observed. Additionally, historic inputs 606 and historic states 614 may be compared during training.

Developing a field specific model 616 may further include testing the field specific model 616. Testing the field specific model 616 may include checking for error 618 in the field specific model 616 and comparing that error 618 to a threshold (e.g., box 624). If the error 618 is less than the threshold, the field specific model 616 may be deployed. However, if the error 618 of the field specific model 616 exceeds the threshold, the field specific model 616 may be returned to training. Once the field specific model 616 has been deployed (e.g., box 626), the deployed field specific model 616 may be used to reduce the training tolerances (e.g., box 628).

While the present application has been described with particular reference to nitrogen sidedressing, it should be noted that similar systems and methods may be used for other nutrients as well. For example, phosphorous, potassium, sulphur, boron, magnesium, calcium, and other nutrients, as well as specific combinations of macro- and micro-nutrients, may be managed using a similar system and method.

It is further noted that while aspects of the present application have been described while referencing particular periods of time (e.g., 7 days, 14 days, or the like), those should be interpreted as illustrative rather than limiting, and any time period may be used. Additionally, crop growth stages may be used. However, any technique used to segment intervals of crop nutrient demand may be used, as long as imagery is leveraged for near-term demand when viable, modeling is used for intermediate and long-term demand when imagery is viable, and modeling is used for all intervals of demand when imagery is not viable.

Referring again to FIG. 1, additional aspects of the system 100 are discussed in greater detail.

The one or more processors 104 of a controller 102 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 104 may include any device configured to execute algorithms and/or instructions (e.g., program instructions stored in memory). In embodiments, the one or more processors 104 may be embodied as a desktop computer, mainframe computer system, workstation, image computer, parallel processor, networked computer, or any other computer system configured to execute a program configured to operate or operate in conjunction with the system 100, as described throughout the present disclosure. Moreover, different subsystems of system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 102 may include one or more controllers housed in a common housing or within multiple housings. In this way, any controller or combination of controllers may be separately packaged as a module suitable for integration into the system 100.

The memory 106 may include any storage medium known in the art suitable for storing program instructions executable by the associated one or more processors 104. For example, the memory 106 may include a non-transitory memory medium. By way of another example, the memory 106 may include, but is not limited to, a read-only memory (ROM), a random-access memory (RAM), a magnetic or optical memory device (e.g., disk), a magnetic tape, a solid-state drive, and the like. It is further noted that the memory 106 may be housed in a common controller housing with the one or more processors 104. In some embodiments, the memory 106 may be located remotely with respect to the physical location of the one or more processors 104 and the controller 102. For instance, the one or more processors 104 of the controller 102 may access a remote memory (e.g., server), accessible through a network (e.g., internet, intranet, and the like).

In embodiments, the system 100 includes a user interface 110 communicatively coupled to the controller 102. In one embodiment, the user interface 110 may include, but is not limited to, one or more desktops, laptops, tablets, and the like. In another embodiment, the user interface 110 includes a display used to display data of the system 100 to a user. The display of the user interface 110 may include any display known in the art. For example, the display may include, but is not limited to, a liquid crystal display (LCD), an organic light-emitting diode (OLED) based display, or a CRT display. Those skilled in the art should recognize that any display device capable of integration with a user interface 110 is suitable for implementation in the present disclosure. In another embodiment, a user may input selections and/or instructions responsive to data displayed to the user via a user input device of the user interface 110.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed is:

1. A system for crop nitrogen management comprising:
a controller, wherein the controller includes one or more processors configured to execute program instructions stored in memory, the program instructions configured to cause the one or more processors to:
receive information of a natural environment and management practices for a specified area of a field;
initiate automated collection of data;
determine if there is a current or approaching nitrogen demand, wherein the approaching nitrogen demand is characterized by one or more of a difference in forecasted uptake greater than zero or a difference in current uptake greater than zero;
estimate the current or approaching nitrogen demand and recommending a rate of nitrogen application based on the estimated approaching nitrogen demand or a near-term crop nitrogen demand; and
calculate at least one nitrogen uptake improvement based on the recommended rate of nitrogen application.

2. The system of claim 1, wherein the one or more processors are further configured to:
develop a field specific model.

3. The system of claim 1, wherein the information of the natural environment and the management practices includes at least one of:
field boundary, crop type, crop hybrid, maturation data, phenotypic performance data, nutrient applications, tillage information, planting information, harvest information, observed weather, forecasted weather, or soil information.

4. The system of claim 1, wherein the automated collection of data includes one or more of image data or sensor data from one or more sensors located in the specified area of the field.

5. The system of claim 1, wherein the recommended rate of nitrogen application is a sum of an intermediate term crop nitrogen demand and a long-term crop nitrogen demand when no optical imagery is available.

6. The system of claim 5, wherein the intermediate term crop nitrogen demand is a 14-day crop nitrogen demand and the long-term crop nitrogen demand is a beyond-14-day crop nitrogen demand.

7. The system of claim 1, wherein the near-term crop nitrogen demand is a 7-day crop nitrogen demand and the approaching nitrogen demand is a nitrogen demand beyond 7 days.

8. The system of claim 1, wherein the recommended rate of nitrogen application is nitrogen demand when optical imagery is available.

9. The system of claim 1, wherein both the at least one nitrogen uptake improvement and the at least one return on investment are accompanied by a probability of the at least one nitrogen uptake improvement and the at least one return on investment.

10. The system of claim 1, wherein the one or more processors are further configured to:
generate a nitrogen uptake improvement heatmap based on the at least one nitrogen uptake improvement.

11. The system of claim 1, wherein the one or more processors are further configured to:
calculate at least one return on investment based on the recommended rate of nitrogen application and the at least one nitrogen uptake improvement.

12. The system of claim 11, wherein the one or more processors are further configured to:
calculate a probability of the at least one nitrogen uptake improvement and the at least one return on investment.

13. The system of claim 11, wherein the one or more processors are further configured to:
generate a return on investment heatmap based on the at least one return on investment.

14. A system for crop nitrogen management comprising:
chemical application equipment;
one or more sensors; and
a controller communicatively coupled to the chemical application equipment and the one or more sensors, wherein the controller includes one or more processors configured to execute program instructions stored in memory, the program instructions configured to cause the one or more processors to:
receive information of a natural environment and management practices for a specified area of a field, wherein the information of the natural environment is received at least partially from the one or more sensors;
initiate automated collection of data, wherein the automated collection of the data includes automated collection of image data or sensor data by the one or more sensors;
determine if there is a current or approaching nitrogen demand, wherein the approaching nitrogen demand is characterized by one or more of a difference in forecasted uptake greater than zero or a difference in current uptake greater than zero;
estimate the current or approaching nitrogen demand and recommending a rate of nitrogen application based on the estimated approaching nitrogen demand or a near-term crop nitrogen demand;
calculate at least one nitrogen uptake improvement based on the recommended rate of nitrogen application; and
control the chemical application equipment based on at least the recommended rate of nitrogen application.

15. The system for crop nitrogen management of claim 14, wherein the processors are further configured to:
calculate at least one return on investment based on the recommended rate of nitrogen application and the at least one nitrogen uptake improvement.

16. The system for crop nitrogen management of claim 15, wherein the processors are further configured to:
calculate a probability of the at least one nitrogen uptake improvement and the at least one return on investment.

17. The system for crop nitrogen management of claim 15, wherein the processors are further configured to:
cause the chemical application equipment to apply nutrients if the at least one return on investment is above a selected threshold.

18. A method of nitrogen management for crops comprising:
configuring a system by receiving information of a natural environment and management practices for a specified area of a field;
initiating automated collection of data;
determining if there is a current or approaching nitrogen demand, wherein the approaching nitrogen demand is characterized by one or more of a difference in forecasted uptake greater than zero or a difference in current uptake greater than zero;
estimating the current or approaching nitrogen demand and recommending a rate of nitrogen application based on the estimated approaching nitrogen demand or a near-term crop nitrogen demand; and
calculating at least one nitrogen uptake improvement based on the recommended rate of nitrogen application.

19. The method of claim 18, further comprising:
developing a field specific model.

20. The method of claim 18, wherein the information of the natural environment and the management practices includes at least one of:
field boundary, crop type, crop hybrid, maturation data, phenotypic performance data, nutrient applications, tillage information, planting information, harvest information, observed weather, forecasted weather, or soil information.

21. The method of claim 18, wherein the automated collection of data includes one or more of image data or sensor data from one or more sensors located in the specified area of the field.

22. The method of claim 18, wherein the recommended rate of nitrogen application is a sum of an intermediate term crop nitrogen demand and a long-term crop nitrogen demand when no optical imagery is available.

23. The method of claim 22, wherein the intermediate term crop nitrogen demand is a 14-day crop nitrogen demand and the long-term crop nitrogen demand is a beyond-14-day crop nitrogen demand.

24. The method of claim 18, wherein the near-term crop nitrogen demand is a 7-day crop nitrogen demand and the approaching nitrogen demand is a nitrogen demand beyond 7 days.

25. The method of claim 18, wherein the recommended rate of nitrogen application is nitrogen demand when optical imagery is available.

26. The method of claim 18, wherein both the at least one nitrogen uptake improvement and the at least one return on investment are accompanied by a probability of the at least one nitrogen uptake improvement and the at least one return on investment.

27. The method of claim 18, further comprising:
generating a nitrogen uptake improvement heatmap based on the at least one nitrogen uptake improvement.

28. The method of claim 18, further comprising:
calculating at least one return on investment based on the recommended rate of nitrogen application and the at least one nitrogen uptake improvement.

29. The method of claim 28, further comprising:
calculating a probability of the at least one nitrogen uptake improvement and the at least one return on investment.

30. The method of claim 28, further comprising:
generating a return on investment heatmap based on the at least one return on investment.
